(19) United States
(12) Patent Application Publication
(10) Pub. No.: US 2019/0119073 A1
(43) Pub. Date: Apr. 25, 2019

(54) ELEVATOR ARRANGEMENT

(71) Applicant: Kone Corporation, Helsinki (FI)

(72) Inventors: Markku HAAPANIEMI, Helsinki (FI); Ari KATTAINEN, Helsinki (FI); Janne MIKKONEN, Helsinki (FI); Matti RASANEN, Helsinki (FI); Jari KANTOLA, Helsinki (FI)

(73) Assignee: Kone Corporation, Helsinki (FI)

(21) Appl. No.: 16/220,317

(22) Filed: Dec. 14, 2018

Related U.S. Application Data
(63) Continuation of application No. PCT/FI2017/050458, filed on Jun. 19, 2017.

(30) Foreign Application Priority Data
Jul. 15, 2016 (FI) PCT/FI2016/050526

(51) Int. Cl. B66B 11/02; B66B 5/00

(52) U.S. Cl. CPC B66B 11/0246; B66B 5/0087; B66B 5/005

(57) ABSTRACT

The invention relates to an elevator arrangement having an elevator comprising an elevator car arranged to run up and down in an elevator shaft along guide rails, an elevator operating system, a control system, a safety system, and an inspection or maintenance mode. The elevator car comprises a roof, a plurality of car walls and a car door. A working connection from inside the elevator car to the elevator shaft is formed via opening a part of or the whole roof of the elevator car and/or a part of or the whole wall of the elevator car and/or the car door. The safety system is arranged to prevent the elevator car from moving if a weight on the roof of the elevator car exceeds a predetermined threshold value.

This application is a continuation of PCT International Application No. PCT/FI2017/050458 which has an International filing date of Jun. 19, 2017, and which claims priority to PCT International Application No. PCT/FI2016/050526 which has an International filing date of Jul. 15, 2016, the entire contents of both of which are incorporated herein by reference.

The present invention relates to an elevator arrangement as defined in the preamble of claim 1.

The invention in question relates particularly to an elevator where a headroom is low. The headroom in this context means the clearance between the roof of the elevator car and the ceiling of the elevator shaft in the situation when the elevator car is at its uppermost position. Various tasks, such as inspections, adjustment works, maintenance or repairs, later referred in a shorter way only as “maintenance work”, are often performed at the upper part of the elevator shaft. In that case, the safety of the persons performing the tasks mentioned above has always to be secured. If the height of the top clearance of the elevator shaft is low, in other words the headroom is low, a sufficient safety space, which prevents injuries occurring for persons working on the roof of the elevator car, cannot always be guaranteed without special procedures.

Usually the maintenance work is done on the roof of the elevator car. In that case, when working on the roof of the elevator car an unintentional movement of the elevator car must be prevented in some other way than by the regular operating brakes of the elevator. It is known in the prior art that this kind of prevention can be done by locking the elevator car and/or the counterweight into their positions on the guide rail, for instance by means of a safety gear, a latch or wedges. However, this often requires that the working persons must separately go to the elevator shaft and perform the locking. That makes safety preparation tasks awkward, laborious and time-consuming.

Another solution according to prior art for achieving an adequate safety space in the upper part of an elevator shaft is to use one or more turnable buffers that are disposed below the counterweight. The buffer is lifted upright before going onto the roof of the elevator car. The length of the buffer is such that the movement of the counterweight, and at the same time the movement of the elevator car, stops before the elevator car rises too high with respect to the ceiling of the elevator shaft. One problem, among others, in this solution is, however, that the shaft space might have been dimensioned so precisely that there is no proper space in the bottom part of the elevator shaft for a turnable buffer. Another problem is that the aforementioned buffer ensuring the top safety space is in the bottom part of the elevator shaft, i.e. right at the other end of the elevator shaft. In that case installing the buffer into the safe position takes extra time and it may also happen that for this reason the person in charge does not remember to go down to the bottom of the elevator shaft to turn them into the safe position.

In addition to the aforementioned, the safety solutions are often based on electrical supervision controls installed in the doors of the shaft, which controls must be switched to the safe position before going onto the roof of the elevator car. Turning the buffers into the safe position and activation of the electrical control circuits are often such a complex combination that, particularly e.g. with small tasks, they might be left undone owing to their complexity and for saving the time used. In addition, electrical supervision control systems could be susceptible to failure.

Yet one solution according to the prior art is shown in the US patent publication No. US2010/0200339 A1. The solution according to the US publication presents an elevator safety system for elevators with a reduced upper end of the elevator shaft. In this solution, the roof of the elevator car cannot be used as a working base, because the roof of the elevator car is constructed so that it does not support weight. Thus, it is not possible to be or work on the roof of the elevator car. In this case, the required free safety space is formed completely inside the elevator car when the elevator car is in its uppermost position. As the roof is not designed to bear loads, in such a situation a weight on the roof may deform or even broke the roof structures. The maintenance work at the top part of the elevator shaft is done inside the elevator car. For this purpose, a part of the sidewall of the car is made removable and the maintenance work is done through the opening in the sidewall when the part mentioned above has been removed from the sidewall. However, the problem in this solution is the fact that there are only limited possibilities to make inspection, repair and maintenance work because only one certain opening is used. And likewise, there are limited possibilities to place elevator appliances that require regular maintenance in the elevator shaft because the opening is only at one sidewall of the car. In addition, the opening makes the wall structure more expensive, more complicated and also weaker than the unbroken wall structure.

One objective of the present invention is to eliminate drawbacks of prior art technology and to achieve an elevator arrangement where there is no need to make any kind of maintenance work on the roof of the elevator car, and where safety actions are performed and the movement of the elevator car is stopped in all situation if someone steps onto the roof of the elevator car. Another objective of the present invention is to achieve a safe space for maintenance work of the elevator appliances in the elevator shaft. And yet another objective of the present invention is to achieve a safety arrangement that is operationally extremely reliable, easy and fast to use, and that immediately prevents the movement of the elevator car if somebody steps onto the roof of the elevator car. Further another objective of the present invention is to achieve an elevator arrangement where the headroom at the upper part of the elevator shaft can be as low as possible, and the elevator shaft is completely inside the building so that there is no need to penetrate the roof of the building.

The elevator arrangement according to the invention is characterized by what is disclosed in the characterization part of claim 1. Other embodiments of the invention are characterized by what is disclosed in the other claims.

The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. Likewise, the different details presented in connection with each embodiment can also be applied in other embodiments. In addition, it can be stated that at least some of the subordinate claims can, in at least some situations, be deemed to be inventive in their own right.

In order to achieve the objectives mentioned above, the present invention provides an elevator arrangement having an elevator comprising an elevator car arranged to run up and down in an elevator shaft along guide rails, an elevator operating system, a control system, a safety system, an inspection or maintenance mode, and where the elevator car comprises a roof, a plurality of car walls and at least one car door, wherein via opening a part of or the whole roof of the elevator car and/or a part of or the whole wall of the elevator car and/or the car door is formed a safe working connection from inside the elevator car to the elevator shaft. Advantageously the safety system is arranged to prevent the elevator car from moving if a weight on the roof of the elevator car exceeds a predetermined threshold value. The operating system basically provides the functions of the elevator arrangement and the control system is basically for controlling and regulating the operating system. These operating system and control system may comprise sub-systems some of them inter-relating and some of them being independent from other subsystems.

In an advantageous embodiment of the invention the elevator arrangement also comprises supporting elements which are arranged to support the roof as long as a predetermined threshold value of the force directed towards the roof does not exceed. For instance, the threshold value may be set to a value that is notably smaller than the weight of a service person. In that case, the threshold value may preferably be, for example, any value between about 10 kg and 25 kg, suitably for instance about 15 kg.

Also in an advantageous embodiment of the invention the elevator arrangement comprises means to prevent the access to the elevator shaft and/or onto the roof of the elevator car through the landing door openings of the building. This kind of access prevention may be arranged by locking systems or by using appropriate control arrangements. For instance, the locking system may be arranged so that there is no access to the locks of the landing doors from outside the elevator shaft. In that case the special access to the shaft may be only through the lowest landing door opening.

One advantage of the solution according to the invention is all necessary safety actions can be performed and a movement of the elevator car can be effectively, reliably and safely prevented if somebody steps onto the roof of the elevator car or there is more weight than a predetermined value allows on the elevator car. Another advantage is that the solution is very easy and quick to use, and does require neither awkward working in the elevator shaft nor preliminary procedures at the top end or bottom end of the elevator shaft. Yet another advantage is also that the solution is inexpensive and simple to implement. A further advantage is that uplifted roof protects the working person in the elevator car from possible falling objects in the elevator shaft. Yet a further advantage of the invention is that the invention enables a safe way of providing an elevator that has an extremely low top clearance or headroom. The top clearance can even be minimized to the minimum, or close to the minimum, required only by the trajectory of the elevator car. Thus, when the elevator car is in its uppermost possible position on its trajectory, the shaft space above the elevator car is small and the height of the elevator shaft can easily be fitted inside the building, without penetrating the roof of the building.

In the following, the invention will be described in detail by the aid of example embodiments by referring to the attached simplified and diagrammatic drawings, wherein

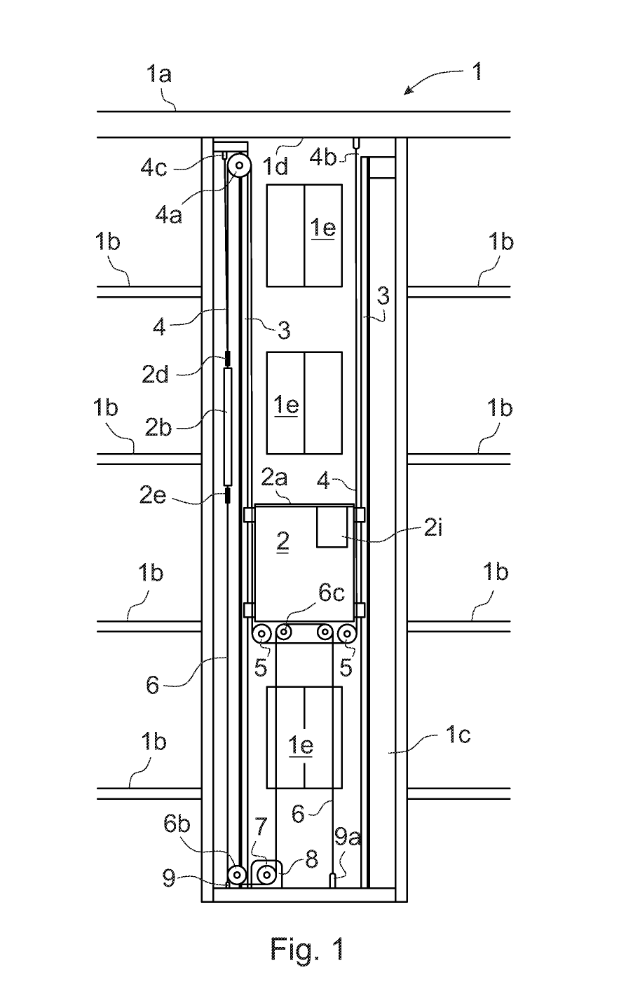

FIG. 1 presents in a simplified and diagrammatic back view a part of the building where the back wall of the elevator shaft is removed, and an elevator in the elevator shaft, in which elevator the solution according to the invention can be used,

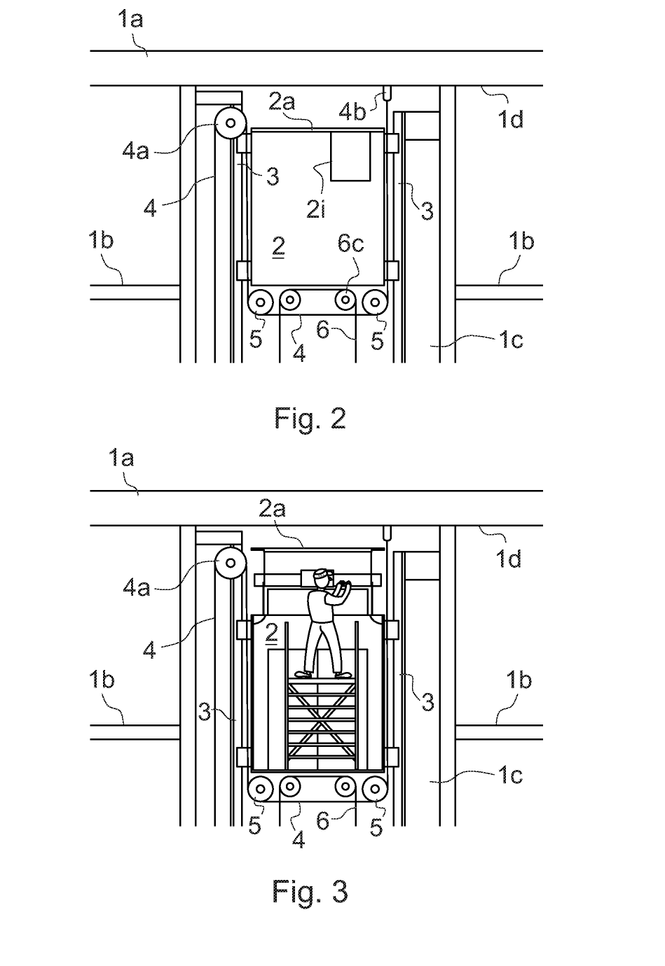

FIG. 2 presents in a simplified and diagrammatic back view the upper part of the elevator shaft in the building according to FIG. 1,

FIG. 3 presents in a simplified and diagrammatic back view the upper part of the elevator shaft in the building according to FIG. 1 in the situation where the maintenance or repair task is in progress,

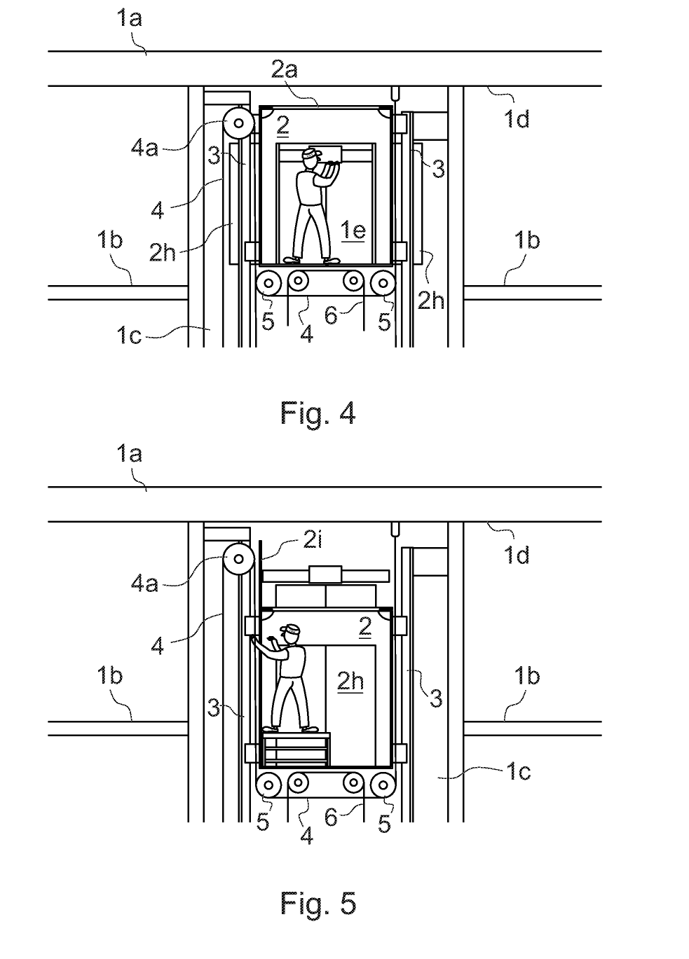

FIG. 4 presents in a simplified and diagrammatic back view the upper part of the elevator shaft in the building according to FIG. 1 in the situation where the maintenance or repair task is in progress through the door of the elevator car,

FIG. 5 presents in a simplified and diagrammatic back view the upper part of the elevator shaft in the building according to FIG. 1 in the situation where the maintenance or repair task is in progress through an opening in a sidewall of the elevator car,

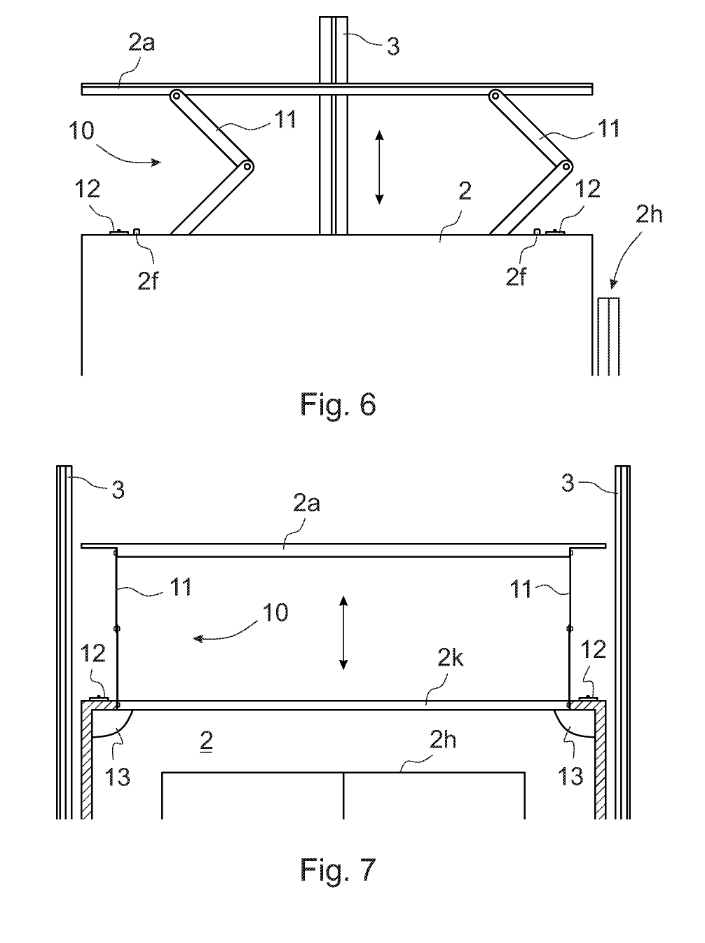

FIG. 6 presents in a simplified and diagrammatic side view an upper part of the elevator car according to the invention when the roof is open for maintenance work,

FIG. 7 presents in a simplified and diagrammatic back view an upper part of the elevator car according to FIG. 6 when the roof is lifted upwards,

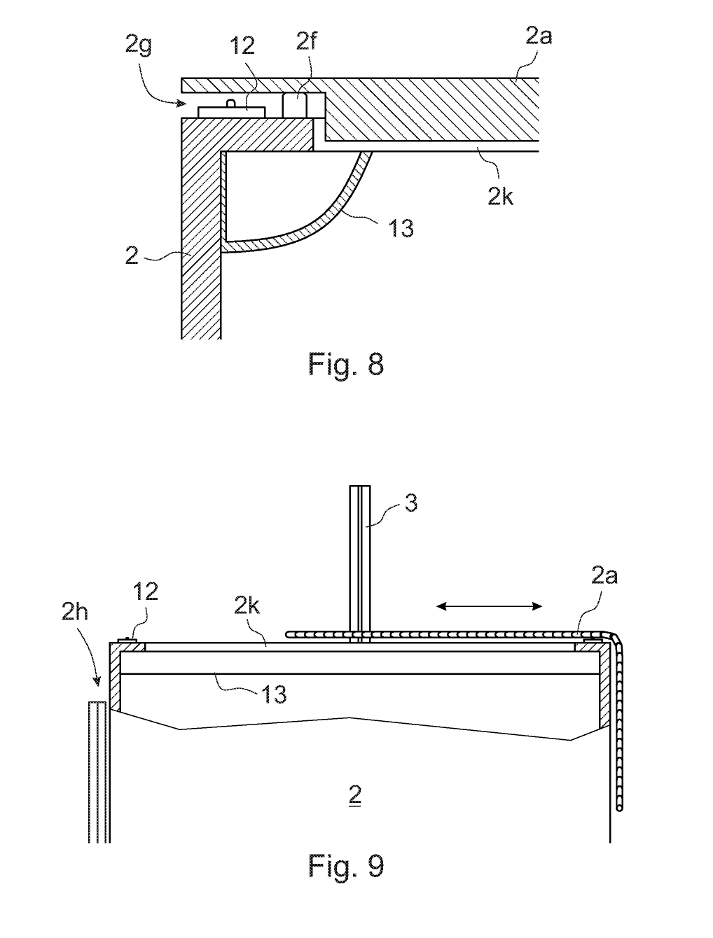

FIG. 8 presents in a simplified and diagrammatic enlarged view an upper corner of the elevator car according to FIG. 7 when the roof is in its closed position,

FIG. 9 presents in a simplified and diagrammatic side view an upper part of the elevator car according to another embodiment of the invention when the roof is partially open for maintenance work,

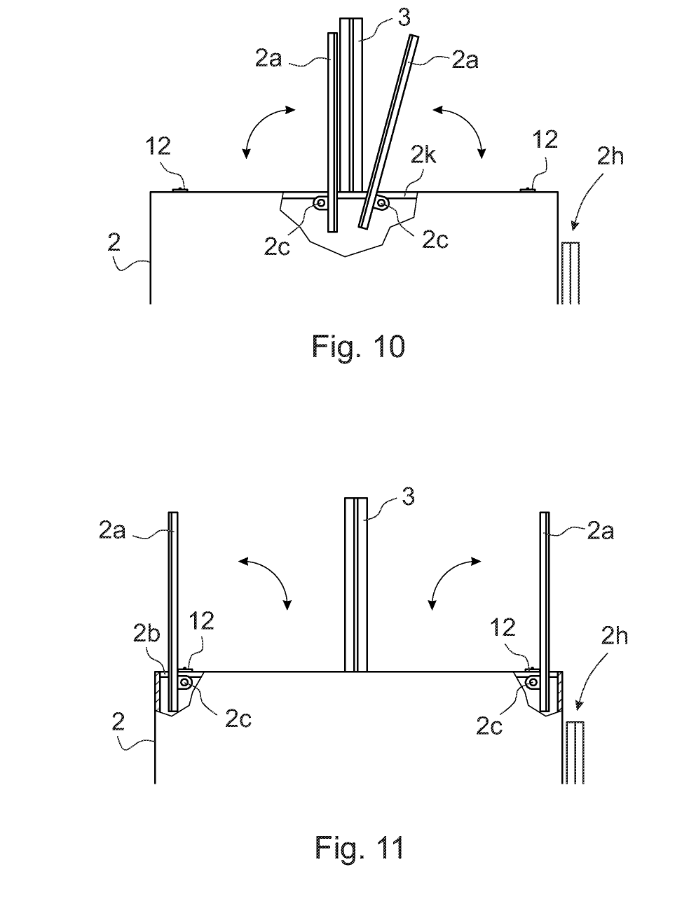

FIG. 10 presents in a simplified and diagrammatic side view an upper part of the elevator car according to yet another embodiment of the invention when the roof is open for maintenance work, and

FIG. 11 presents in a simplified and diagrammatic side view an upper part of the elevator car according to yet another embodiment of the invention when the roof is open for maintenance work.

An aspect of the invention is to achieve an elevator arrangement with an elevator car having several possibilities to access maintenance and repair targets in an elevator shaft from inside the elevator car, and which also removes the need to step onto the roof of the elevator car, and even triggers all the safety actions and stop the movement of the elevator car if somebody steps onto the roof of the elevator car. In addition, another aspect of the invention is to achieve an elevator arrangement that reduces the height of the elevator shaft needed.

FIG. 1 presents in a simplified and diagrammatic back view a part of the building 1 where the back wall of the elevator shaft 1c is removed, and an elevator in the elevator shaft 1c, in which elevator the solution according to the invention can be used. The building 1 has a roof 1a just above the elevator shaft 1c and four floors 1b served by the elevator. The number of floors 1b can vary.

The elevator comprises among other things an elevator car 2 that is arranged to run up and down in the elevator shaft 1c along guide rails 3, and a counterweight or balance weight 2b that is also arranged to run up and down in the elevator shaft 1c along its guide rails which are not presented in FIG. 1 for the sake of clarity. Later in this connection only balance weight 2b is mentioned when either counterweight or balance weight is meant.

The elevator car 2 is equipped with an openable roof 2a and with one or more covered maintenance openings 2i on one or more walls of the elevator car 2. The maintenance openings 2i can be opened to make it possible to access maintenance and repair targets in the elevator shaft 1c from inside the elevator car 2. Advantageously the maintenance openings 2i have been placed onto the wall or walls of the elevator car 2 in such predefined locations where connections from inside the elevator car 2 to the maintenance and repair targets are best possible to perform maintenance and repair works needed. Preferably the size of the maintenance openings 2i is as small as possible in order to keep the structure of the walls as strength as possible.

Advantageously the supporting and moving of the elevator car 2 are separated from each other. This makes it possible to achieve an elevator structure where the height of the headroom above the elevator car 2 can be as low as possible. The elevator car 2 is driven by a hoisting machinery 8 equipped with a drive wheel 7. Advantageously the hoisting machinery 8 is located at the bottom part of the elevator shaft 1c, below the elevator car 2 and advantageously below the first floor level 1b.

A traction member 6 is connected between the balance weight 2b and the elevator car 2. The traction member 6 can be a single member or a bunch of similar parallel members, for instance, the traction member 6 can be a toothed belt, chain or other type of member that does not slip on the drive wheel 7. In this embodiment, the suspension ratio of the traction member 6 is 2:1. In that case the first end of the traction member 6 is secured at its first fastening point 9, for example at the bottom part of the elevator shaft 1c. From the first fastening point 9 the traction member 6 is led upwards to go over and around a diverting pulley 2e in connection with the balance weight 2b and from the diverting pulley 2e the traction member 6 is led downwards to go under and around a diverting pulley 6b and the drive wheel 7 of the hoisting machinery 8 at the bottom part of the elevator shaft 1c, from where the traction member 6 continues upwards to go over and around diverting pulleys 6c at the bottom of the elevator car 2 and from the diverting pulleys 6c again downwards to its second fastening point 9a where the second end of the traction member 6 is secured, for example at the bottom part of the elevator shaft 1c.

The elevator car 2 is suspended by suspension element 4 that is connected between the balance weight 2b and the elevator car 2. The suspension element 4 can be a single member or a bunch of similar parallel members, for instance suspension ropes. In this embodiment, the suspension ratio of the suspension element 4 is 2:1. In that case the first ends of the suspension element 4 are secured at their first fastening point 4c, for example at the top part of the guide rail 3, from which the suspension element 4 is led downwards to go under and around a diverting pulley 2d in connection with the balance weight 2b. From the diverting pulley 2d the suspension element 4 is led upwards to go over and around a diverting pulley 4a that is fitted with bearings on its shaft, for instance at the upper part of the guide rail 3. From the diverting pulley 4a the suspension element 4 descends downwards to go under and around diverting pulleys 5 at the bottom of the elevator car 2 and from the diverting pulleys 5 the suspension element 4 is led upwards to its second fastening point 4b where the second end of the suspension element 4 is secured, for example at the top part of the guide rail 3. The elevator car 2 is also equipped with safety gear system that is arranged to stop the movement of the elevator car 2 and to lock the elevator car 2 into the guide rails 2 when needed. Thanks to the suspension like this the roof 2a of the elevator car 2 can be openable.

Each floor has a landing door 1e that is presented in FIG. 1 seen from the direction of the elevator shaft 1c. In addition, the elevator comprises at least an operating system, a control system, an electrical system, a variety of sensor arrangements and a safety system comprising an inspection mode, which inspection mode is here a common term for the operation mode which is activated when performing inspection, maintenance or repair work or other operations that require a safe working environment.

FIG. 2 presents in a simplified and diagrammatic back view the upper part of the elevator shaft 1c in the building 1 according to FIG. 1. Also in this figure, the back wall of the elevator shaft 1c is removed and the elevator shaft 1c is seen from its backside. In the situation of FIG. 2 the elevator car 2 is in its uppermost floor 1b in the top part of the elevator shaft 1c. The top clearance between the roof 2a of the elevator car 2 and the ceiling 1d of the elevator shaft 1c is at its minimum.

FIG. 3 presents in a simplified and diagrammatic back view the upper part of the elevator shaft 1c in the building 1 according to FIG. 1 in the situation where the maintenance or repair task is in progress. The openable roof 2a of the elevator car 2 is opened in this embodiment by lifting it upwards in this embodiment, and a maintenance hole or opening is created between the uplifted roof 2a and the upper edges of the elevator car 2. The elevator car 2 has been run with a service run or inspection run in an appropriate location in the elevator shaft 1c so that the working person being inside the elevator car 2 has an easy access to the elevator components and appliances in the elevator shaft. In this case, the required safety space is created at least partly inside the elevator car 2. The uplifted roof 2a protects the working person also from falling tools and other objects that may fall down into the elevator shaft 1c from other working sites above, for instance from a top part of a neighboring elevator shaft where another elevator is installed at the same time.

FIG. 4 presents in a simplified and diagrammatic back view the upper part of the elevator shaft 1c in the building 1 according to FIG. 1 in the situation where the maintenance or repair task is in progress through the door 2h of the elevator car 2. In this case, the roof 2a of the elevator car 2 is not openable or it is openable like mentioned above and below but there is no need to open it now because the maintenance or repair task can be done through the opened door 2h.

FIG. 5 presents in a simplified and diagrammatic back view the upper part of the elevator shaft in the building according to FIG. 1 in the situation where the maintenance or repair task is in progress through a maintenance opening 2i in a sidewall of the elevator car 2. The maintenance opening 2i and possibly other maintenance openings 2i on the same wall or on the other walls of the elevator car 2 are preferably placed precisely to the locations which provide an easy connection from inside the elevator car 2 to a maintenance or repair target in the elevator shaft 1c.

In the cases according to FIGS. 4 and 5 the elevator car 2 has been run with a service run or inspection run into an appropriate height position in the elevator shaft 1c so that the working person being inside the elevator car 2 has an easy access to the elevator components and appliances in the elevator shaft 1c. In these cases, the required safety space is created totally inside the elevator car 2.

Regardless of the maintenance openings 2i on the walls of the elevator car 2 the same elevator car 2 may or may not have an openable roof 2a for the maintenance or repair tasks as mentioned above and below, and also the door 2h of the elevator car 2 can be used for the maintenance or repair tasks. Thus, the same elevator car 2 may have three different types of access from inside the elevator car 2 to the maintenance or repair targets in the elevator shaft 1c, i.e. the openable roof 2a, the maintenance openings 2i on the walls of the elevator car 2 and the door 2h of the elevator car 2.

FIGS. 6-8 present in a simplified and diagrammatic view, an upper part of the elevator car 2 according to the invention. In FIGS. 6 and 7 the roof 2a is open for a maintenance or repair work and a created manhole or opening 2k on top of the elevator car 2 makes it possible to reach the elevator appliances or components in the elevator shaft 1c from inside the elevator car 2. In FIG. 7 the back walls of the elevator shaft 1c and the elevator car 2 are removed and the elevator shaft 1c and elevator car 2 are seen from their backside. FIG. 8 presents in an enlarged side view an upper corner of the elevator car 2 according to FIG. 5 when the roof 2a is in its closed position.

In the embodiment of FIGS. 3 and 6-8 the roof 2a is openable by lifting it straight upwards. For that purpose, the elevator comprises opening means 10 that are arranged to open and close the roof 2a when the elevator is switched on to a safe inspection or maintenance mode, later in a shorter way referred only as “inspection mode”. The moving of the roof 2a can be carried out in several ways. One way is to use articulated arms 11 and one or more actuators, for example gas springs to turn the articulated arms 11. In this embodiment four articulated arms 11 are used, two pieces on each side of the elevator car 2. The actuators are not presented in the figures.

The elevator also comprises supporting elements 2f on the upper edges of the elevator car 2, which supporting elements 2f are arranged to support the descended roof 2a so that there is a narrow gap 2g for ventilation between the roof 2a and the upper edges of the elevator car. The supporting element 2f can be a gas spring or a fuse-like element that is arranged to support the roof as long as a predetermined threshold value of the force directed towards the roof does not exceed. For instance, if the threshold value is set to 25 kg, the elevator works as normal until something heavier than 25 kg is placed onto the roof 2a of the elevator car 2. In that case, the support of the supporting elements 2f yields and the roof 2a descends slightly downwards and triggers the safety control switches 12 that are situated between the roof 2a and the upper edges of the elevator car 2.

The elevator comprises a safety arrangement that is connected to the control system of the elevator. The safety control switches 12 belong to the safety system of the elevator safety arrangement and are arranged to cut the safety circuit of the elevator when a weight greater than the predetermined threshold value is on the roof 2a of the elevator car 2, for instance if a human being steps onto the roof 2a. The cutting of the safety circuit prevents elevator car 2 from moving away from its position as long as the elevator safety system is again reset. This improves the safety of the elevator.

FIGS. 7 and 8 also present a corner casing 13 that is fastened at an upper corner inside the elevator car 2. The elevator car 2 may comprise one or more corner casings 13 at the upper corners of the interior of the elevator car 2. The corner casings 13 may comprise car lighting and other electrical appliances, and also apertures for elevator car ventilation.

FIG. 9 presents in a simplified and diagrammatic side view an upper part of the elevator car 2 according to another embodiment of the invention when the roof 2a is partially open for a maintenance or repair work. In this embodiment, the roof 2a is a flexible door comprising narrow slats, which are connected to each other in a way that they can make a part of the roof 2a bend downwards at the upper corner of the elevator car 2 when the roof 2a is opening and sliding away from the top of the manhole or opening 2k. The safety arrangement of the elevator of this type with safety control switches 12 and supporting elements 2f can be essentially similar to what is described above.

FIG. 10 presents in a simplified and diagrammatic side view an upper part of the elevator car 2 according to yet another embodiment of the invention when the roof 2a is open for maintenance or repair work. In this embodiment, the roof 2a consists of two halves that are hinged with a hinge 2c at their first ends at the upper part of the sidewalls of the elevator car 2 in the middle area of the elevator car 2. Thus, the halves of the roof 2a are closing towards the front edge and back edge of the elevator car 2 and opening towards the center of the elevator car 2. This gives more space for maintenance work in the backside of the elevator car 2 and in the front side of the elevator car 2 where, for example the door machinery is.

FIG. 11 presents in a simplified and diagrammatic side view an upper part of the elevator car 2 according to yet another embodiment of the invention when the roof 2a is open for maintenance or repair work. In this embodiment, the roof 2a also consists of two halves that are hinged with a hinge 2c at their first ends at the upper part of the sidewalls of the elevator car 2. In this case, the hinge points are close the front wall and back wall of the elevator car 2. In this case, the halves of the roof 2a are closing towards the center of the elevator car 2 and opening towards the front edge and back edge of the elevator car 2. This gives more space for maintenance work in the sides of the elevator car 2 where, for example the guide rails are.

In the embodiments of FIGS. 10 and 11 the safety arrangement of the elevator with safety control switches 12 and supporting elements 2f can be essentially similar to what is described above in connection with other embodiments of the invention. The safety arrangement of this type stops the movement of the elevator car 2 if someone steps onto the roof 2a of the elevator car 2.

It is obvious to the person skilled in the art that the invention is not restricted to the examples described above but that it may be varied within the scope of the claims presented below. Thus, for instance the roof of the elevator car and the mechanisms for opening and closing the roof can be different from what is presented above.

It is also obvious to the person skilled in the art that the suspension and/or traction ratio of the elevator car can be different from what is presented above. The suspension and/or traction ratio can be, for instance 1:1, the suspension ratio can also be 2:1 but the traction ratio 1:1. However, it is essential that the elevator structure is such that the roof of the elevator car can be easily opened.

It is further obvious to the person skilled in the art that the suspension and traction arrangement of the elevator car can be different from what is presented above. The location of the hoisting machinery can also be in the upper part of the elevator shaft, and the suspension and traction of the elevator car can be carried out in different ways, for instance with common hoisting ropes that suspend the elevator car and the balance weight and also moves them.

1. Elevator arrangement having an elevator comprising an elevator car arranged to run up and down in an elevator shaft along guide rails, an elevator operating system, a control system, a safety system, an inspection or maintenance mode, and where the elevator car comprises a roof, a plurality of car walls and at least one car door, wherein via opening a part of or the whole roof of the elevator car and/or a part of or the whole wall of the elevator car and/or the car door is formed a working connection from inside the elevator car to the elevator shaft, wherein the safety system is arranged to prevent the elevator car from moving if a weight on the roof of the elevator car exceeds a predetermined threshold value.

2. Elevator arrangement according to claim 1, wherein the safety system of the elevator comprises support elements on the top edges of the elevator car to support the roof when the roof is closed, and which support elements are arranged to yield under the roof if a weight on the roof exceeds a predetermined threshold value.

3. Elevator arrangement according to claim 1, wherein the safety system of the elevator comprises one or more safety control switches on the top edges of the elevator car to trigger the safety circuit off in order to prevent the elevator car from moving when the support elements have yielded and let the roof descend downwards.

4. Elevator arrangement according to claim 1, wherein the safety system of the elevator is arranged to prevent the elevator car from moving after the triggering of the safety control switches as long as the elevator safety system is again reset.

5. Elevator arrangement according to claim 1, wherein the elevator arrangement comprises access to the maintenance or repair targets in the elevator shaft from inside the elevator car through an opening on top of the elevator car.

6. Elevator arrangement according to claim 1, wherein the elevator arrangement comprises access to the maintenance or repair targets in the elevator shaft from inside the elevator car through one or more maintenance openings on one or more walls of the elevator car.

7. Elevator arrangement according to claim 1, wherein the elevator arrangement comprises access to the maintenance or repair targets in the elevator shaft from inside the elevator car through the door of the elevator car.

8. Elevator arrangement according to claim 5, wherein the elevator comprises opening means that are enabled to open and close the roof only when the elevator is switched on to the inspection or maintenance mode.

9. Elevator arrangement according to claim 8, wherein the opening means are arranged to open and close the roof essentially in a vertical direction.

10. Elevator arrangement according to claim 8, wherein the opening means are arranged to open and close the roof essentially in a horizontal direction.

11. Elevator arrangement according to claim 8, wherein the roof comprises two essentially similar halves, that are hinged at the upper part of the elevator car essentially in the central area of the elevator car, and that the opening means are arranged to open and close the halves of the roof turning the halves around the hinges towards the center line of the elevator car when opening the halves and towards the front and back walls of the elevator car when closing the halves.

12. Elevator arrangement according to claim 8, wherein the roof comprises two essentially similar halves, that are hinged at the upper part of the elevator car close to the front and back wall of the elevator car, and that the opening means are arranged to open and close the halves of the roof turning the halves around the hinges towards front and back walls of the elevator car when opening the halves and towards the center line of the elevator car when closing the halves.
